(19) United States
(12) Patent Application Publication
(10) Pub. No.: US 2015/0372537 A1
(43) Pub. Date: Dec. 24, 2015

(54) SYSTEMS AND METHODS FOR PREVENTING ELECTRIC POWER CONVERTERS FROM OPERATING IN SLEEP MODE

(71) Applicant: Emerson Network Power, Energy Systems, North America, Inc., Warrenville, IL (US)

(72) Inventors: Michael Francis SMITH, Columbia Station, OH (US); Paul Brian HIIDEL, Strongsville, OH (US); Julie JoAnn LEE, Huron, OH (US)

(21) Appl. No.: 14/741,203

(22) Filed: Jun. 16, 2015

Related U.S. Application Data
(60) Provisional application No. 62/013,798, filed on Jun. 18, 2014.

(51) Int. Cl. H02J 9/06; H02J 7/00

(52) U.S. Cl. CPC H02J 9/061; H02J 7/0068

(57) ABSTRACT

A system for providing power to a load includes an output converter configured to provide power to a load, at least one battery coupled to the output converter, an input converter coupled to the at least one battery and the output converter, and a control circuit coupled to the input converter. The input converter is configured to provide an output voltage and an output current to the at least one battery and the output converter. The control circuit is configured to regulate the output voltage of the input converter at a defined voltage level to prevent the output converter from operating in a sleep mode. Other example systems, control circuits etc. are also disclosed.

### CROSS-REFERENCE TO RELATED APPLICATION

This application claims the benefit of U.S. Provisional Application No. 62/013,798 filed Jun. 18, 2014. The entire disclosure of the above application is incorporated herein by reference.

### FIELD

The present disclosure relates to systems and methods for preventing electric power converters from operating in sleep mode.

### BACKGROUND

This section provides background information related to the present disclosure which is not necessarily prior art.

Electric power systems sometimes include a primary power source and a backup power source for providing backup power to an electric load when the primary power source is removed and/or unable to satisfy load requirements due to, for example, a loss of input power, malfunction, etc. It is desirable for the backup power source to provide its power to the load as quickly as possible after the primary power source falters.

Commonly, the backup power source includes an output converter for regulating the output of the backup power source. Typically, the output converter enters a sleep mode (e.g., a standby mode, etc.) to conserve power, improve efficiency in the system, etc. when the backup power source is not needed. For example, the output converter may operate in its sleep mode by employing pulse skipping control, etc.

### SUMMARY

This section provides a general summary of the disclosure, and is not a comprehensive disclosure of its full scope or all of its features.

According to one aspect of the present disclosure, a system for providing power to a load includes an output converter configured to provide power to a load, at least one battery coupled to the output converter, an input converter coupled to the at least one battery and the output converter, and a control circuit coupled to the input converter. The input converter is configured to provide an output voltage and an output current to the at least one battery and the output converter. The control circuit is configured to regulate the output voltage of the input converter at a defined voltage level to prevent the output converter from operating in a sleep mode.

According to another aspect of the present disclosure, a control circuit for a battery backup unit (BBU) configured to provide power to a load is disclosed. The BBU includes an output converter configured to provide power to a load, at least one battery coupled to the output converter, and an input converter coupled to the at least one battery and the output converter. The input converter is configured to provide an output voltage and an output current to the at least one battery and the output converter. The control circuit is configured to couple to the input converter and regulate the output voltage of the input converter at a defined voltage level to prevent the output converter from operating in a sleep mode.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a system including an output converter that is prevented from operating in its sleep mode according to one example embodiment of the present disclosure.

FIG. 2 is a block diagram of a system including a battery and a control circuit for monitoring a charge state of the battery according to another example embodiment.

FIG. 3 is a block diagram of a system including an output converter and a control circuit for controlling the output converter according to yet another example embodiment.

FIG. 4 is a block diagram of a system including an input converter and a BBU having a converter that is prevented from operating in its sleep mode according to another example embodiment.

FIG. 5 is a block diagram of a BBU including an input converter and an output converter that is prevented from operating in its sleep mode according to yet another example embodiment.

FIG. 6 is a block diagram of a system including a primary power source and three BBUs coupled to the primary power source according to another example embodiment.

FIG. 7 is a block diagram of a system including an AC/DC converter, a Li-Ion battery pack, and a DC/DC output converter according to yet another example embodiment.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

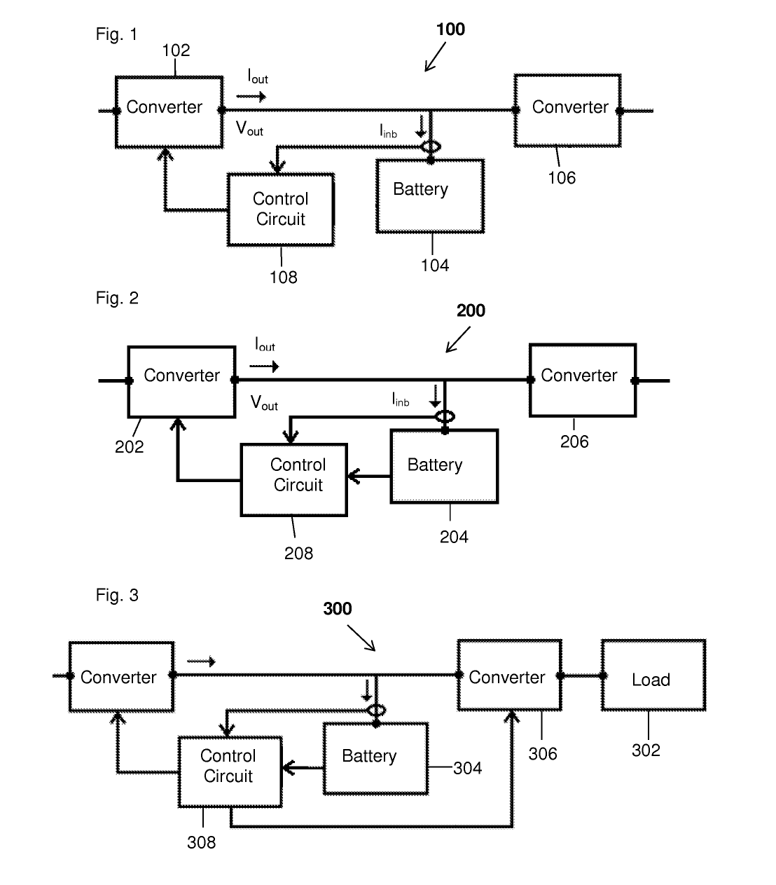

A system for providing power to a load according to one example embodiment of the present disclosure is illustrated in FIG. 1 and indicated generally by reference number 100. As shown in FIG. 1, the system 100 includes an output converter 106 configured to provide power to a load (not shown), a battery 104 coupled to the converter 106, an input converter 102 coupled to the battery 104 and the converter 106, and a control circuit 108 coupled to the converter 102. The input converter 102 is configured to provide an output voltage (Vout) and an output current (Iout) to the battery 104 and the output converter 106. The control circuit 108 is configured to regulate the output voltage (Vout) of the input converter 102 at a defined voltage level to prevent the output converter 106 from operating in a sleep mode.

By employing the systems disclosed herein, converters may be maintained in an active mode, and thus in a ready state and not a sleep mode (sometimes referred to as a standby mode, etc.). As a result, when an output converter (e.g., the output converter 106) is required to provide power to a load, the converter can provide a desired regulated voltage to the load more quickly than if the converter was in a sleep mode or the like.

For example, the output converter 106 of FIG. 1 may be a component of a battery backup unit (BBU) for providing backup power to a load when a primary power source is removed and/or unable to do so due to, for example, a loss of input power, malfunction, etc. If the output converter 106 is in a sleep mode (e.g., in a low-power mode of operation) and the primary power source is unable to provide adequate power to the load, the output converter 106 may not be able to provide a desired regulated voltage quickly enough to sustain the load. This may be due to, for example, a load transient caused by a load current step from zero amperes to full load after the converter exits its sleep mode.

However, if the converter 106 receives a small amount of voltage from the converter 102 and/or the battery 104, the converter 106 may pass a small amount of current to its output (e.g., which may be lost through heat dissipation, etc.). As a result, the converter 106 may be prevented from operating in its sleep mode. As such, the converter 106 may be able to more rapidly provide its full load output to sustain the load because the converter remains in its active mode (e.g., a mode of operation where the converter provides at least some power), has a smaller load current step (e.g., from the small amount of current to full load), etc.

For example, the output converter 106 (and/or other output converters disclosed herein) may include an output capacitor (not shown) that may discharge (e.g., at least partially discharge) if the output converter 106 enters a sleep mode. In such cases, the output capacitor may be required to charge before the output converter 106 can regulate its output voltage at the desired regulated voltage. However, if the output converter 106 is prevented from entering a sleep mode (as explained herein), the output capacitor may remain charged. As such, the output converter 106 can regulate its output voltage at the desired regulated voltage without having to charge the output capacitor. As a result, the output converter 106 may provide the desired regulated voltage quickly enough to sustain the load.

As explained above, the control circuit 108 of FIG. 1 regulates the output voltage (Vout) at a defined voltage level to prevent the output converter 106 from operating in a sleep mode. This defined voltage level may be any suitable voltage. Generally speaking, it is preferable to regulate the voltage (Vout) at a lowest possible voltage (while still preventing the converter 106 from entering a sleep mode) to maximize efficiency. For example, the defined voltage level may be a voltage between about 10.8V and about 15V (e.g., 12V, 14V, etc.), more than 15V, less than 10.8V, etc. In some embodiments, the defined voltage level may be at least partially based on a defined current level as further explained below, a particular parallel and/or series combination of batteries when the battery 104 includes multiple batteries, etc.

In some embodiments, the defined voltage level may be stored in memory of the system 100 (e.g., in the control circuit 108), determined based on one or more sensed parameters in the system 100, etc. In some examples, the defined voltage level may adjust from one level to another level based on sensed parameters, etc.

In some embodiments, the control circuit 108 may optionally monitor an input current (Iinb) to the battery 104, and in response to this input current (Iinb) equaling a defined current level, regulate the output voltage (Vout) of the input converter 102 at the defined voltage level as explained above. If the input current (Iinb) does not equal (e.g., the current (Iinb) is greater than the defined current level), the control circuit 108 may regulate the output voltage (Vout) of the input converter 102 at a different voltage level (e.g., a voltage higher than the defined voltage level).

For example, and as shown in FIG. 1, the control circuit 108 may monitor the input current (Iinb) by sensing the battery input current (Iinb) and receiving a signal indicative of the battery input current (Iinb). In the example of FIG. 1, the input current (Iinb) may be sensed by any suitable current sensing device including, for example, a series sense resistor, a current transformer, a Hall Effect sensor, etc.

The defined current level may be any suitable current level. In some examples, the defined current level may be greater than zero. For example, the defined current level may be near zero. In some embodiments, the defined current level may be less than or equal to about one tenth percent ( 1/10%) of an output current of the output converter 106. For example, if the output current is 100 amperes, the defined current level may be about 0.1 amperes or less.

Additionally and/or alternatively, the control circuit 108 may determine a charge state (e.g., sometimes referred to as a state of charge) of the battery 104, and in response to the battery 104 having available capacity, decrease the output voltage (Vout) of the input converter 102 to the defined voltage level. In some examples, the control circuit 108 may decrease the voltage (Vout) of the input converter 102 to the defined voltage level when the battery 104 is in its substantially charged state. In such examples, the control circuit 108 may regulate the output voltage (Vout) of the input converter 102 at the defined voltage level to maintain the battery 104 in its substantially charged state.

The control circuit 108 may determine a charge state of the battery 104 in any suitable manner including, for example, by monitoring one or more parameters in the system. In such examples, the control circuit 108 can calculate a charge state of the battery 104 based on these parameters, set parameters, etc. In other embodiments, the control circuit 108 may receive a signal from the battery 104 indicative of a charge state.

For example, FIG. 2 illustrates a system 200 substantially similar to the system 100 of FIG. 1. The system 200 includes the input converter 102, the battery 104, and the output converter 106 of FIG. 1 and a control circuit 208. The control circuit 208 is similar to the control circuit 108 of FIG. 1, but receives one or more signals from the battery 104 indicating its charge state.

Once the control circuit 208 determines the battery 104 has available capacity (e.g., is charged, etc.), the control circuit 208 can regulate the voltage (Vout) of the input converter 102 at the defined voltage level. Thus, if energy is available from the input converter 102 (e.g., the input converter 102 is able to provide its voltage (Vout) as explained above, etc.) and/or the battery 104 has available capacity, the control circuit 208 may sense one or both conditions and keep the output converter 106 active as explained above.

For example, the input converter 102 can provide a voltage (Vout) sufficient to charge the battery 104. This voltage may be higher than the defined voltage level. When the control circuit 208 determines the battery 104 is charged, the control circuit 208 can decrease the voltage (Vout) to the defined voltage level and then regulate the voltage (Vout) at the defined voltage level as explained above.

In some examples, decreasing the voltage (Vout) causes the battery input current (Iinb) to decrease. In such examples, once the battery input current (Iinb) reaches the defined current level (e.g., substantially zero, etc.), the control circuit 208 can regulate the voltage (Vout) at the defined voltage level as explained above. Thus, although the battery input current (Iinb) may be substantially zero, the output converter 106 may continue to receive a small amount of current (e.g., Iout-Iinb) from the input converter 102.

Additionally, because the output voltage (Vout) is regulated when the input current (Iinb) to the battery 104 is substantially zero, the system 100 (and other systems including the features disclosed herein) may substantially avoid providing a trickle charge to the battery 104 when the battery is in its fully charged state.

In other embodiments, the control circuit 108 may also control the output converter 106. For example, FIG. 3 illustrates another system 300 including the output converter 106 coupled to a load 302, and a control circuit 308 coupled to the output converter 106. The control circuit 308 may be substantially similar to the control circuit 108 of FIG. 1. The control circuit 308 of FIG. 3, however, can provide and/or receive one or more control signals to and/or from the output converter 106. This may allow the control circuit 308 to control an output (e.g., a regulated output, etc.) of the output converter 106. For example, the control circuit 308 may control the output converter 106 to provide a regulated voltage to the load 302 when a primary power source (not shown) for powering the load 302 is unable to do so as explained above.

Additionally, although FIG. 3 illustrates the control circuit 308 receiving signals from the battery 104 as explained above relative to FIG. 2, it should be clear that this is an optional feature and thus the control circuit 308 may not receive such signals if desired. For example, the control circuit 308 may not monitor the state of the battery 104, may monitor one or more parameters in the system 300 to determine the state of the battery 104, etc.

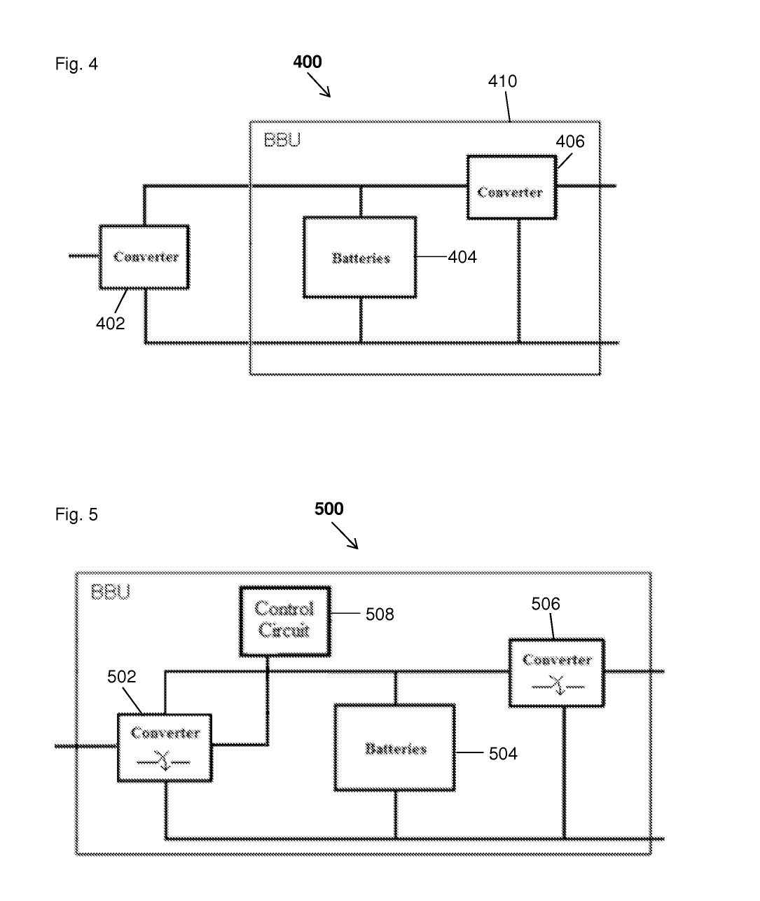

In some embodiments, the batteries and/or one or both converters disclosed herein may be components of a battery backup unit (BBU) for providing power to a load as explained above. For example, FIG. 4 illustrates a system 400 including a converter 402, and a BBU 410 having one or more batteries 404 and a converter 406. The BBU 410 may provide backup power to a load (not shown) when a primary power source (e.g., the converter 402 and/or another power source) is unable to do so as explained above.

The converter 402, the batteries 404, and the converter 406 may be substantially similar to the input converter 102, the battery 104, and output converter 106, respectively, of FIG. 1. Additionally, the input converter 102 may be (or at least a part of) a primary power source as explained above.

Further, although not shown, the system 400 of FIG. 4 may include a control circuit including, for example, any one of the control circuits disclosed herein for controlling the converters 402, 406, monitoring parameters, etc. In some embodiments, the control circuit (or at least a part of the control circuit) may be a component of the BBU 410. Alternatively, the control circuit may be positioned external to the BBU 410.

FIG. 5 illustrates a BBU 500 including a converter 502, one or more batteries 504, a converter 506, and a control circuit 508 coupled to the converter 502. The converter 502, the batteries 504, and the converter 506 of FIG. 5 may be substantially similar to the input converter 102, the battery 104, and the output converter 106, respectively, of FIG. 1. The control circuit 508 may be any suitable control circuit including, for example, any one of the control circuits disclosed herein.

Additionally, the input converters and/or the output converters may include one or more power switches. For example, and as shown in FIG. 5, the converter 502 and the converter 506 of the BBU 500 include at least one power switch. As a result, the control circuits disclosed herein may regulate an output voltage of one or both converters by providing one or more control signals to one or more power switches in the input converter. For example, the control signals may include a pulse width modulation (PWM) signal, a pulse frequency modulation (PFM) signal, etc.

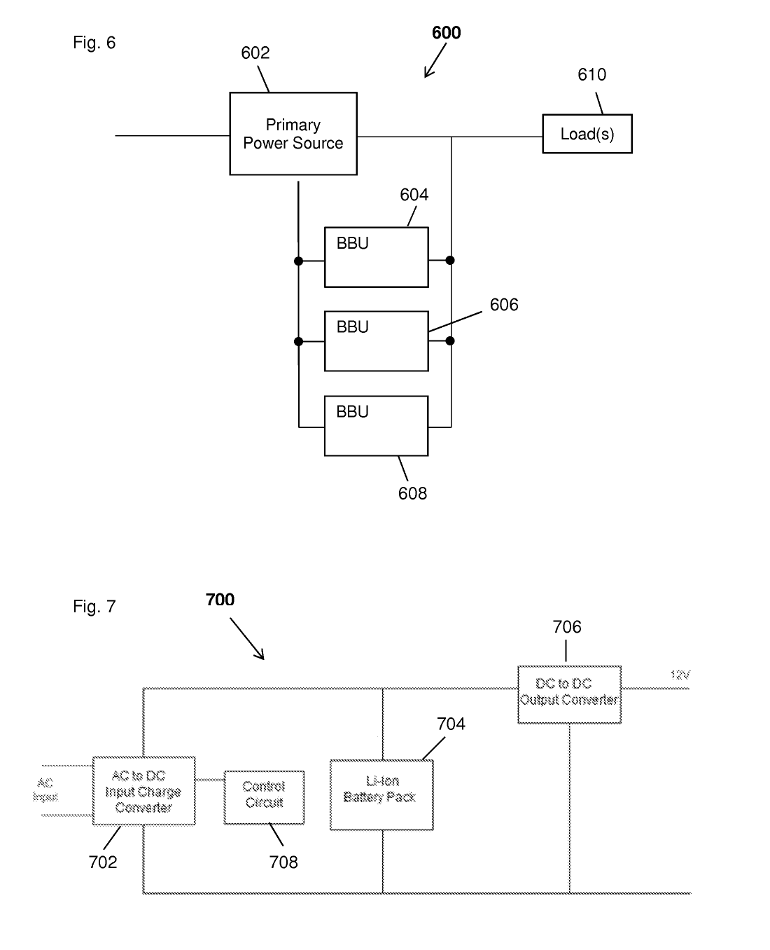

In some examples, a system may include multiple BBUs with one or more of the BBUs including an output converter that is prevented from operating in its sleep mode as explained above. For example, FIG. 6 illustrates a system 600 including a primary power source 602 for providing power to one or more loads 610, and three BBUs 604, 606, 608 coupled in parallel for providing backup power to the loads 610 as explained above. In the example of FIG. 6, each BBU includes an output converter (e.g., the output converter 106 of FIG. 1) that is prevented from operating in its sleep mode as explained above.

The input converters and/or the output converter disclosed herein may include any suitable converter(s). For example, and as further explained below, the input converters may include a DC/DC converter, an AC/DC converter (e.g., commonly referred to a rectifier), etc. and the output converters may include a DC/DC converter, a DC/AC inverter (e.g., if AC power is desired), etc. The input converters and/or the output converter may have any suitable topology (e.g., a buck converter, boost converter, bridge converters, etc.) and, in some cases, be part of a power supply (e.g., switched mode power supply, etc.).

The batteries disclosed herein may be any suitable number and type of rechargeable battery including, for example, a lithium ion (Li-ion) battery, a nickel metal hydride (NiMH) battery, a nickel cadmium (NiCd) battery, etc. In some embodiments, all of the batteries in a system may include the same type of rechargeable battery. For example, all of the batteries in a system may include Li-Ion batteries. In other embodiments, some of the batteries in a system may be one type of rechargeable batteries (e.g., Li-Ion batteries, etc.) and other batteries in the system may be another type of rechargeable batteries (e.g., NiCd batteries, etc.).

FIG. 7 illustrates another example system 700 including an input converter 702, a battery pack 704 (e.g., one or more batteries), an output converter 706, and a control circuit 708 coupled to the converter 702. As shown in FIG. 7, the input converter 702 includes an AC/DC input charge converter, the battery pack 704 includes a Li-Ion battery pack 704, and the output converter 706 includes a DC/DC output converter providing a regulated 12 volt output to a load (not shown).

Additionally, the example systems disclosed herein may be employed in any suitable application including, for example, DC power applications and/or AC power applications. For example, the example systems may be used in telecommunication applications, information technology applications, etc. In some embodiments, the systems may be employed in electronic equipment enclosures (e.g., data racks, server cabinets, etc.) including, for example, stationary and/or modular enclosures.

Further, the systems may provide any suitable output power including, for example, AC power and/or DC power. In some embodiments, the systems may provide 5 VDC, 12 VDC, 24 VDC, 48 VDC, 400 VDC, 120 VAC, etc.

The control circuits disclosed herein may include an analog control circuit, a digital control circuit (e.g., a digital signal processor (DSP), a microprocessor, a microcontroller, etc.), or a hybrid control circuit (e.g., a digital control circuit and an analog control circuit). Thus, the methods disclosed herein may be performed by a digital controller. Further, one or more portions of the control circuit may be an integrated circuit (IC).

Additionally, the control circuits may be a portion of a system control circuit (e.g., a system control card (SCC), etc.) for a system including a battery pack, an input converter, and/or an output converter. Alternatively, the control circuits may be a dedicated control circuit for one battery pack, one input converter, and/or one output converter if desired. If the battery pack, the input converter, and/or the output converter are components of a BBU as explained above, the control circuits may be an external control circuit (e.g., a system control circuit external the BBU, etc.), an internal control circuit within the BBU, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for providing power to a load, the system comprising:
an output converter configured to provide power to a load;
at least one battery coupled to the output converter;
an input converter coupled to the at least one battery and the output converter, the input converter configured to provide an output voltage and an output current to the at least one battery and the output converter; and
a control circuit coupled to the input converter, the control circuit configured to regulate the output voltage of the input converter at a defined voltage level to prevent the output converter from operating in a sleep mode.

2. The system of claim 1 wherein the control circuit is configured to determine a charge state of the at least one battery, and in response to the at least one battery having available capacity, decrease the output voltage of the input converter to the defined voltage level.

3. The system of claim 1 wherein the control circuit is configured to monitor an input current to the at least one battery, and in response to the input current to the at least one battery equaling a defined current level, regulate the output voltage of the input converter at the defined voltage level.

4. The system of claim 3 wherein the defined current level is greater than zero.

5. The system of claim 3 wherein the defined current level is not more than about one tenth percent ( 1/10%) of an output current of the output converter.

6. The system of claim 1 wherein the defined voltage level is a voltage between about 10.8V and about 15V.

7. The system of claim 1 wherein the at least one battery includes a Li-Ion battery.

8. The system of claim 7 wherein the input converter includes a rectifier.

9. The system of claim 8 wherein the output converter includes a DC/DC converter.

10. The system of claim 1 wherein the control circuit includes a digital control.

11. The system of claim 1 wherein the at least one battery and the output converter are components of a battery backup unit.

12. The system of claim 1 wherein the input converter, the at least one battery, and the output converter are components of a battery backup unit.

13. The system of claim 1 wherein the control circuit is configured to regulate the output voltage of the input converter at the defined voltage level to maintain the least one battery in a substantially charged state.

14. A control circuit for a battery backup unit configured to provide power to a load, the BBU including an output converter configured to provide power to a load, at least one battery coupled to the output converter, and an input converter coupled to the at least one battery and the output converter, the input converter configured to provide an output voltage and an output current to the at least one battery and the output converter, the control circuit configured to couple to the input converter and regulate the output voltage of the input converter at a defined voltage level to prevent the output converter from operating in a sleep mode.

15. The control circuit of claim 14 wherein the control circuit is configured to determine a charge state of the at least one battery, and in response to the at least one battery being in the substantially charged state, decrease the output voltage of the input converter to the defined voltage level.

16. The control circuit of claim 14 wherein the control circuit is configured to monitor an input current to the at least one battery, and in response to the input current to the at least one battery equaling a defined current level, regulate the output voltage of the input converter at the defined voltage level.

17. The control circuit of claim 16 wherein the defined current level is greater than zero.

18. The control circuit of claim 16 wherein the defined current level is not more than about one tenth percent ( 1/10%) of an output current of the output converter.

19. The control circuit of claim 14 wherein the defined voltage level is a voltage between about 10.8V and about 15V.

20. The control circuit of claim 14 wherein the control circuit includes a digital control.
